(19) United States
(12) Patent Application Publication
(10) Pub. No.: US 2017/0197591 A1
(43) Pub. Date: Jul. 13, 2017

(54) DUAL BLADE WINDSHIELD WIPER

(71) Applicant: Christopher Taylor, Guymon, OK (US)

(72) Inventor: Christopher Taylor, Guymon, OK (US)

(21) Appl. No.: 14/994,406

(22) Filed: Jan. 13, 2016

(51) Int. Cl. B60S 1/38

(52) U.S. Cl. CPC B60S 1/3806; B60S 2001/3822; B60S 2001/3831; B60S 2001/3834

(57) ABSTRACT

A dual blade windshield wiper including; a blade anchor; a first blade extension extending from the blade anchor on a first side; a second blade extension extending from the blade anchor on a second side; a first blade at the distal end of the first blade extension, where the first blade is comprised of a first substance; and a second blade at the distal end of the second blade extension, where the second blade is comprised of a second substance. In one particular embodiment, the first substance is a scrubbing material and the second substance is a plurality of bristles. The blade anchor preferably includes an inner cavity and a sponge lies within the inner cavity, where a clip secures the sponge within the inner cavity.

### BACKGROUND OF THE INVENTION

Field of Invention

The present invention relates to the dual blade windshield wiper that implements two blades to wipe clear a windshield.

Description of Related Art

It's well known windshield wipers are used to clear water, snow or other debris from the surface of a windshield. Typically the windshield wiper is used on a motor vehicle although windshield wipers are also used on boats, aircraft and trains. Generally the windshield wiper is attached to an arm that rotates and rotates the wiper across the surface of the windshield. The wiper is usually a soft rubber that allows for the movement of the blade across the surface of the windshield. As the blade moves across the surface of the windshield, the water or other precipitation is removed and such movement is repeated over a sequence related to the rotation of the blade within a range suitable for the windshield. Although many different types of blades are used it is still advantageous to have further designs to effectively wipe the windshield surface. The windshield wiper blades of the prior art are occasionally ineffective and leave streaking and may be unable to remove other debris that comes in contact with the windshield. Many times dirt, dust and bugs are smashed against the windshield therefore making it difficult for the blade to effectively clear the vision for a driver. As a result, further developmental windshield wiper blades are necessary to create even more effective wiper blades.

### SUMMARY OF THE INVENTION

The present invention relates to a dual blade windshield wiper including; a blade anchor; a first blade extension extending from the blade anchor on a first side; a second blade extension extending from the blade anchor on a second side; a first blade at the distal end of the first blade extension, where the first blade is comprised of a first substance; and a second blade at the distal end of the second blade extension, where the second blade is comprised of a second substance. In one particular embodiment, the first substance is a scrubbing material and the second substance is a plurality of bristles. The blade anchor preferably includes an inner cavity and a sponge lies within the inner cavity, where a clip secures the sponge within the inner cavity.

### BRIEF DESCRIPTION OF DRAWINGS

FIG. 1 depicts a sectional view of a wiper blade in accordance with the present invention.

FIG. 2 depicts a bottom view of a wiper blade in accordance with the present invention.

### DETAILED DESCRIPTION

The present invention relates to a dual blade windshield wiper that includes a first blade and a second blade extending from a wiper anchor that forms essentially a U-shape. In one particular embodiment of the present invention, the first blade includes a scrubber at the tip and a second blade may include a brush or bristles to provide a more effective mean of clearing the surface of the windshield wiper. Further aspects of the present invention includes a sponge at the peak of the wiper anchor on an inside channel of the wiper blade. The present invention as a result provides a more effective means for clearing the surface of the windshield. Use of the scrubber, sponge and bristle provides a more effective wiping tool. The sponge is held within a cavity through the use of a clip that secures the sponge in the middle cavity of the wiper anchor.

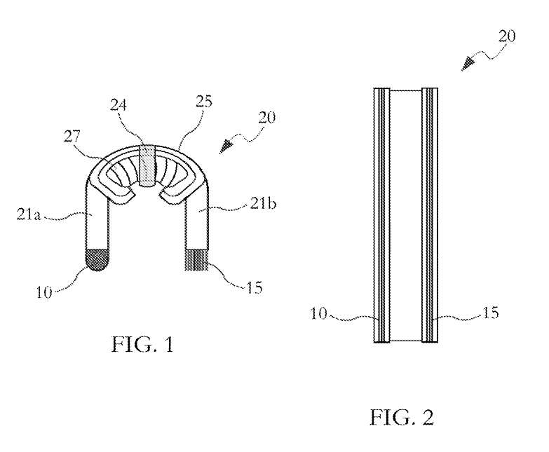

In reference to FIG. 1, a sectional view of a wiper 20 in accordance with the present invention is depicted. The wiper 20 includes a first blade extension 21a and a second blade extension 21b that extend from a blade anchor 25. The blade anchor 25 is the base portion of the composite wiper 20. At the tip of the first blade extension 21a is a scrubber 10. The scrubber 10 may be in the form of a scrubber or sponge providing a first means of windshield surface contact. The second blade extension 21b includes a bristle tip 15. The scrubber 10 and bristle tip 15 are used in conjunction to provide an effective means to clear the surface of the windshield. On an inside cavity of the blade anchor 25 is a sponge 27. The sponge 27 is held in place with a clip 24. The sponge 27 helps to absorb moisture as it repels within the inner portion of the blade 20 of the wiper 20.

FIG. 2 provides a bottom view of the wiper 20, where is the scrubber 10 and bristle tip 15 are shown running parallel along the length of the wiper 20. This windshield wiper 20 may be installed on a conventional windshield wiper arm and provide an after market replacement wiper for conventional wiper. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dual blade windshield wiper comprising;
a. a blade anchor;
b. a first blade extension extending from the blade anchor on a first side;
c. a second blade extension extending from the blade anchor on a second side;
d. a first blade at the distal end of the first blade extension, where the first blade is comprised of a first substance; and
e. a second blade at the distal end of the second blade extension, where the second blade is comprised of a second substance.

2. The dual blade windshield wiper according to claim 1, where the first substance is a scrubbing material.

3. The dual blade windshield wiper according to claim 1, where the second substance is a plurality of bristles.

4. The dual blade windshield wiper according to claim 1, where the blade anchor includes an inner cavity and a sponge lies within the inner cavity.

5. The dual blade windshield wiper according to claim 4, where a clip secures the sponge within the inner cavity.
